(19) United States
(12) Patent Application Publication
(10) Pub. No.: US 2024/0053504 A1
(43) Pub. Date: Feb. 15, 2024

(54) OBJECT DETECTION DEVICE

(71) Applicant: NUCTECH COMPANY LIMITED, Beijing (CN)

(72) Inventors: Yuan MA, Beijing (CN); Lei LIU, Beijing (CN); Weizhen WANG, Beijing (CN); Quanwei SONG, Beijing (CN); Lingjun GONG, Beijing (CN); Xinbo ZHU, Beijing (CN); Long DU, Beijing (CN); Guangming XU, Beijing (CN); Xingliang ZHAI, Beijing (CN); Lina HOU, Beijing (CN); Shangmin SUN, Beijing (CN); Chunguang ZONG, Beijing (CN); Yu HU, Beijing (CN)

(21) Appl. No.: 18/260,010

(22) PCT Filed: Nov. 23, 2021
(86) PCT No.: PCT/CN2021/132262

§ 371 Date: Jun. 29, 2023

(30) Foreign Application Priority Data
Dec. 31, 2020 (CN) 202011644320.2

(51) Int. Cl. G01V 5/00

(52) U.S. Cl. CPC G01V 5/0008

(57) ABSTRACT

An object detection device is provided, including: a support structure, a ray source assembly, and a detector assembly. The support structure is configured to form a passageway for a passage of a detected object; the ray source assembly is configured to emit a ray; and the detector assembly includes a detector mounting frame connected to the support structure and a plurality of detection units arranged on the detector mounting frame, the detection unit being configured to receive a transmission ray penetrating the detected object and obtain a detection information based on the transmission ray; the support structure includes a vertical support arm having an adjustable height, and a vertical distance from the ray source assembly to a bottom portion of the support structure varies with a height of the vertical support arm. Another object detection device is further provided, including a ray source assembly, a detector assembly and a controller.

### CROSS-REFERENCE TO RELATED APPLICATION

This application is a Section 371 National Stage Application of International Application No. PCT/CN2021/132262, filed on Nov. 23, 2021, entitled “OBJECT DETECTION DEVICE,” which claims priority to Chinese Application No. 202011644320.2, filed on Dec. 31, 2020, incorporated herein by reference in their entirety.

### TECHNICAL FIELD

Embodiments of the present disclosure relate to a field of security inspection, and in particular to an object detection device.

### BACKGROUND

In order to ensure public security and reduce illegal and criminal activities, objects such as vehicles need to be inspected at the Customs, airports, ports and other places. A security inspection may include detecting whether there are prohibited items in an object. For example, an X-ray object inspection system may perform a non-invasive imaging detection on an object without opening the object such as a vehicle, and has a very wide range of applications in the field of public security, the Customs, and frontier inspection etc. In some cases, an object inspection system needs to be transferred to different places for inspection. But, some object inspection systems have many components and complex constitution, and the systems are large in size, which are not convenient for transfer.

### SUMMARY

According to one aspect of the present disclosure, there is provided an object detection device, including: a support structure, configured to form a passageway for a passage of a detected object; a ray source assembly, configured to emit a ray; and a detector assembly, including a detector mounting frame connected to the support structure and a plurality of detection units arranged on the detector mounting frame, the detection unit being configured to receive a transmission ray penetrating the detected object and obtain a detection information based on the transmission ray; wherein, the support structure includes a vertical support arm having an adjustable height, and a vertical distance from the ray source assembly to a bottom portion of the support structure varies with a height of the vertical support arm.

According to the embodiments of the present disclosure, the ray source assembly includes a ray source cabin connected to the support structure and a ray source located in the ray source cabin; and the ray source cabin has a plurality of emission positions, the ray source is configured to sequentially emit a ray from the plurality of emission positions to the detected object in the passageway, and centerlines of rays emitted from any two emission positions of the plurality of emission positions form an included angle to perform a multi-view transmission on the detected object.

According to the embodiments of the present disclosure, the ray source is configured as one of: the ray source is a movable ray source, and the movable ray source is configured to be sequentially moved to the plurality of emission positions and emit a ray; the ray source is a distributed ray source, the distributed ray source includes a plurality of emission units corresponding to the plurality of emission positions one to one, and the plurality of emission units are configured to sequentially emit a ray; and the ray source includes a plurality of independent ray sources, the plurality of independent ray sources are respectively arranged at the plurality of emission positions, and the plurality of independent ray sources are configured to sequentially emit a ray.

According to the embodiments of the present disclosure, the vertical support arm includes a first support arm and a second support arm, and each of the first support arm and the second support arm is a telescopic structure; the support structure further includes a transverse cabin connected between the first support arm and the second support arm; and the ray source cabin is connected to the transverse cabin, and the ray source cabin is configured to move along an extending direction of the transverse cabin.

According to the embodiments of the present disclosure, the transverse cabin is configured to house a cooling device and a controller; and the cooling device is configured to cool the ray source, and the controller is at least configured to control the ray source.

According to the embodiments of the present disclosure, the detector mounting frame includes a transverse mounting frame and a vertical mounting frame, and the vertical mounting frame includes a first vertical mounting frame and a second vertical mounting frame respectively arranged on two sides of the transverse mounting frame; wherein a height of at least one of the first vertical mounting frame and the second vertical mounting frame is adjustable; or a height of at least one of the first vertical mounting frame and the second vertical mounting frame is variable with a height of the vertical support arm.

According to the embodiments of the present disclosure, the vertical support arm includes a first support arm connected to the first vertical mounting frame and a second support arm connected to the second vertical mounting frame; wherein, a bottom portion of the first vertical mounting frame is rotatably connected to a bottom portion of the first support arm, and the first vertical mounting frame is configured to rotate around the bottom portion of the first support arm, so as to adjust a height of the first vertical mounting frame; and/or a bottom portion of the second vertical mounting frame is rotatably connected to a bottom portion of the second support arm, and the second vertical mounting frame is configured to rotate around the bottom portion of the second support arm, so as to adjust a height of the second vertical mounting frame.

According to the embodiments of the present disclosure, the first support arm includes a first support segment and a second support segment that is telescopic relative to the first support segment; and the first vertical mounting frame includes a first mounting segment fixedly connected to the first support segment and a second mounting segment fixedly connected to the second support segment, so that a length of the first vertical mounting frame varies with a telescoping of the second support segment.

According to the embodiments of the present disclosure, the plurality of emission positions are distributed in a plane perpendicular to a travelling direction defined by the passageway; and the ray source is arranged so that rays emitted at the plurality of emission positions are all coplanar with the plurality of detection units; wherein, the ray source is configured so that rays emitted at partial emission positions of the plurality of emission positions are incident at least from a top portion of the detected object, and rays emitted by the ray source at partial emission positions of the plurality of emission positions are incident at least from a second side edge of the detected object.

According to the embodiments of the present disclosure, a connecting line of the plurality of emission positions is in an arc shape or a zigzag shape, wherein a vertical distance from an emission position at a first end to a bottom portion of the support structure is greater than a vertical distance from an emission position at a second end to the bottom portion of the support structure; and the ray source assembly is located in a corner area of the support structure and is close to a top portion and a second side portion of the support structure.

According to the embodiments of the present disclosure, the vertical support arm includes a first support arm and a second support arm, and the ray source assembly is connected between the first support arm and the second support arm; wherein, the support structure further includes a base seat connected to the first support arm and the second support arm, each of the first support arm and the second support arm is configured to rotate relative to the base seat, and during a rotation of the first support arm and the second support arm relative to the base seat, a height of the ray source assembly varies; or each of the first support arm and the second support arm is a telescopic structure, and during a telescoping process of the first support arm and the second support arm, the height of the ray source assembly varies.

According to the embodiments of the present disclosure, the object detection device further includes: a controller, configured to control the ray source to sequentially emit a ray from the plurality of emission positions to the detected object, and control the plurality of detection units to sequentially obtain a detection information corresponding to a ray emitted from each emission position; and a processor, configured to obtain a scanned image at a viewing angle corresponding to each emission position according to the detection information, and perform a three-dimensional reconstruction processing according to the scanned image at a viewing angle corresponding to each emission position.

According to the embodiments of the present disclosure, the ray source assembly further includes a collimator, the collimator being located on a side of a ray emission of the ray source cabin, and the collimator being configured to adjust a ray emitted from the plurality of emission positions; wherein, in a case that the ray source is a distributed ray source, the collimator is a segmented collimator, and a parameter of each segment of the collimator is adjusted separately; and in a case that the ray source includes a plurality of independent ray sources, the collimator is an integral collimator, and a parameter of the integral collimator is adjusted uniformly.

According to the embodiments of the present disclosure, the object detection device further includes: a conveying device, arranged at the bottom portion of the support structure, and configured to convey the detected object to pass through the passageway; an anti-collision sensor, arranged at the vertical support arm, and configured to detect a distance between the detected object and the vertical support arm; wherein the controller is further configured to control the conveying device, the ray source and the plurality of detection units according to the distance between the detected object and the vertical support arm.

According to the embodiments of the present disclosure, the object detection device further includes: a collection device, configured to collect an identification information of the detected object; wherein the processor is further configured to: establish a corresponding relationship between the identification information of the detected object and the scanned image.

According to the embodiments of the present disclosure, the processor is further configured to: determine a target detection mode from a plurality of preset detection modes according to a current detection portion of the detected object, and perform a detection on the detected object based on the target detection mode; wherein, in different detection modes, different numbers of emission positions are used to emit a ray; in a first scanning mode of a plurality of scanning modes, a single emission position of the plurality of emission positions is used to emit a ray; in a second scanning mode of the plurality of scanning modes, the plurality of emission positions are used to emit a ray.

According to the embodiments of the present disclosure, the processor is further configured to: determine one or more target emission positions from the plurality of emission positions according to a user instruction; and the controller is further configured to: control the ray source to sequentially emit a ray to the detected object at the one or more target emission positions.

According to the embodiments of the present disclosure, the first support segment and the second support segment are provided with a guide structure for defining a moving direction of the second support segment; and/or the first support segment and/or the second support segment is provided with a locking device for restricting a movement of the second support segment after the second support segment moves to a set position of the first support segment.

According to the embodiments of the present disclosure, the object detection device further includes: two protective baffles, respectively connected to two sides of the support structure, the protective baffle having an unfolded state and a folded state; wherein, when the protective baffle is in the unfolded state, the two protective baffles both extend along the traveling direction defined by the passageway; and when the protective baffle is in the folded state, the two protective baffles are folded to two sides of the passageway.

According to another aspect of the present disclosure, there is further provided an object detection device, including: a ray source assembly, including a ray source cabin and a ray source located in the ray source cabin, the ray source cabin having a plurality of emission positions; a detector assembly, including a detector mounting frame and a plurality of detection units arranged on the detector mounting frame, wherein the detector mounting frame includes a transverse mounting frame and a first vertical mounting frame and a second vertical mounting frame respectively arranged on two sides of the transverse mounting frame; and a controller, configured to control the ray source to sequentially emit a ray from the plurality of emission positions, and control the detection unit to sequentially receive a ray emitted from each emission position of the plurality of emission positions, wherein centerlines of rays emitted from any two emission positions of the plurality of emission positions form an included angle.

According to the embodiments of the present disclosure, the ray source is configured as one of the following: the ray source is a movable ray source, and the movable ray source is configured to be sequentially moved to the plurality of emission positions and emit a ray; the ray source is a distributed ray source, the distributed ray source includes a plurality of emission units corresponding to the plurality of emission positions one to one, and the plurality of emission units are configured to sequentially emit a ray; and the ray source includes a plurality of independent ray sources, the plurality of independent ray sources are respectively arranged at the plurality of emission positions, and the plurality of independent ray sources are configured to sequentially emit a ray.

According to the embodiments of the present disclosure, a connecting line of the plurality of emission positions is in an arc shape or a zigzag shape, wherein a vertical distance from an emission position at a first end to a bottom portion of the object detection device is greater than a vertical distance from an emission position at a second end to the bottom portion of the object detection device.

### BRIEF DESCRIPTION OF THE DRAWINGS

In order to better understand the embodiments of the present disclosure, the embodiments of the present disclosure will be described in detail according to the accompanying drawings as follows:

FIG. 1A and FIG. 1B schematically show application scenarios of an object detection device according to the embodiments of the present disclosure;

FIG. 2A schematically shows a schematic front view of an object detection device according to the embodiments of the present disclosure;

FIG. 2B schematically shows a schematic left view of the object detection device shown in FIG. 2A;

FIG. 3 schematically shows a schematic view of a ray beam emitted from an emission position L1 according to the embodiments of the present disclosure;

FIG. 4 schematically shows a schematic view of a ray beam emitted from an emission position L6 according to the embodiments of the present disclosure;

FIG. 5A schematically shows a schematic view of a ray source cabin in a first position according to the embodiments of the present disclosure;

FIG. 5B schematically shows a schematic view of the ray source cabin in a second position according to the embodiments of the present disclosure;

FIG. 6 schematically shows a schematic view of a first vertical mounting frame and a second vertical mounting frame in a lowered state according to the embodiments of the present disclosure;

FIG. 7A schematically shows a schematic view of an object detection device according to another embodiment of the present disclosure;

FIG. 7B schematically shows a schematic view of a first vertical mounting frame in a lowered state according to another embodiment of the present disclosure;

FIG. 8A and FIG. 8B schematically show a schematic view of an object detection device according to another embodiment of the present disclosure;

FIG. 9 schematically shows a schematic view of a ray source assembly according to the embodiments of the present disclosure; and

FIG. 10A, FIG. 10B and FIG. 10C schematically show schematic views of a protective baffle according to the embodiments of the present disclosure.

### DETAILED DESCRIPTION OF EMBODIMENTS

Specific embodiments of the present disclosure will be described in detail below, and it should be noted that the embodiments described here are only for illustration, and are not intended to limit the embodiments of the present disclosure. In the following description, numerous specific details are set forth in order to provide a thorough understanding of the embodiments of the present disclosure. However, it will be apparent to those of ordinary skill in the art that these specific details do not need to be used to implement the embodiments of the present disclosure. In other instances, well-known structures, materials or methods are not described in detail to avoid obscuring the embodiments of the present disclosure.

Throughout the specification, a reference to “one embodiment”, “the embodiments”, “one example” or “an example” means that a particular feature, structure, or characteristic described in connection with the embodiment or example is included in at least one embodiment of the present disclosure. Therefore, appearances of the phrase “in one embodiment”, “in the embodiments”, “one example” or “an example” in various places throughout this specification are not necessarily all referring to a same embodiment or example. Furthermore, particular features, structures or characteristics may be combined in any suitable combination and/or sub-combination in one or more embodiments or examples. In addition, those of ordinary skill in the art should understand that the term “and/or” used herein includes any and all combinations of one or more of the associated items listed.

According to the embodiments of the present disclosure, there is provided an object detection device. The device includes a support structure, a ray source assembly, and a detector assembly. The support structure is configured to form a passageway for a passage of a detected object. The ray source assembly is configured to emit a ray. The detector assembly includes a detector mounting frame connected to the support structure and a plurality of detection units arranged on the detector mounting frame, and the detection unit is configured to receive a transmission ray penetrating the detected object and obtain a detection information based on the transmission ray. The support structure includes a vertical support arm having an adjustable height, and a vertical distance from the ray source assembly to a bottom portion of the support structure varies with a height of the vertical support arm.

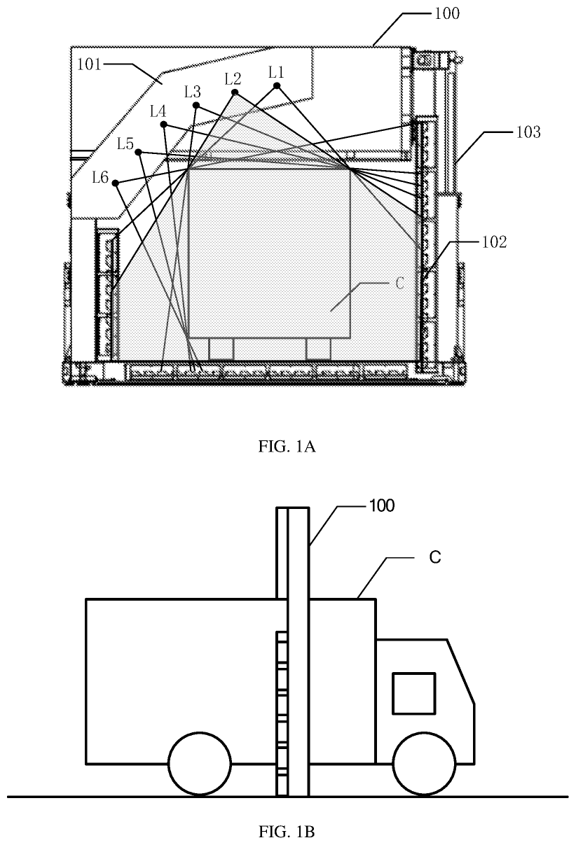

FIG. 1A and FIG. 1B schematically illustrate application scenarios of an object detection device according to the embodiments of the present disclosure. It should be noted that FIG. 1A and FIG. 1B are only examples of scenarios where embodiments of the present disclosure may be applied to help those skilled in the art understand the technical content of the present disclosure, but it does not mean that the embodiments of the present disclosure may not be used in other devices, systems, environments or scenarios.

As shown in FIG. 1A and FIG. 1B, the object detection device 100 of the embodiments of the present disclosure may be used to detect a vehicle C, for example. In a detection process, the vehicle C may enter a passageway formed by the support structure and slowly pass through the passageway. During the slow passage of the vehicle C, each section from a head to to tail of the vehicle C sequentially passes through a plane where the ray source and the detector are located. Therefore, the object detection device may sequentially scan each section of the vehicle, so that a scanned image of the entire vehicle may be finally formed.

The vertical support arm 103 of the object detection device 100 is configured as a structure having a height adjustable, such as a telescopic structure. The ray source assembly 101 may be for example close to a top portion of the support structure, and the detector assembly 102 may be for example mounted on a bottom portion and a side portion of the support structure. When the height of the vertical support arm 103 varies, a height of the ray source assembly 101 also varies accordingly, thereby changing a height of the entire object detection device 100. For example, when the device needs to be transported, the height of the vertical support arm 103 may be lowered, the height of the entire object detection device 100 is also reduced accordingly, and a volume is reduced, which is convenient for movement and transportation. When the device needs to be used for detection, the height of the vertical support arm 103 may be raised, and the height of the entire object detection device 100 may also be raised accordingly, so that the vehicle C may pass through the passageway and a detection may be performed on the vehicle C. Here, the height mentioned in the embodiments of the present disclosure may be understood as a height relative to the bottom portion of the support structure, i.e., a vertical distance from the bottom portion of the support structure.

It may be understood that the application scenarios in FIG. 1A and FIG. 1B are only examples, and the object detection device may also be applied to any other objects that need to be detected in addition to detecting vehicles.

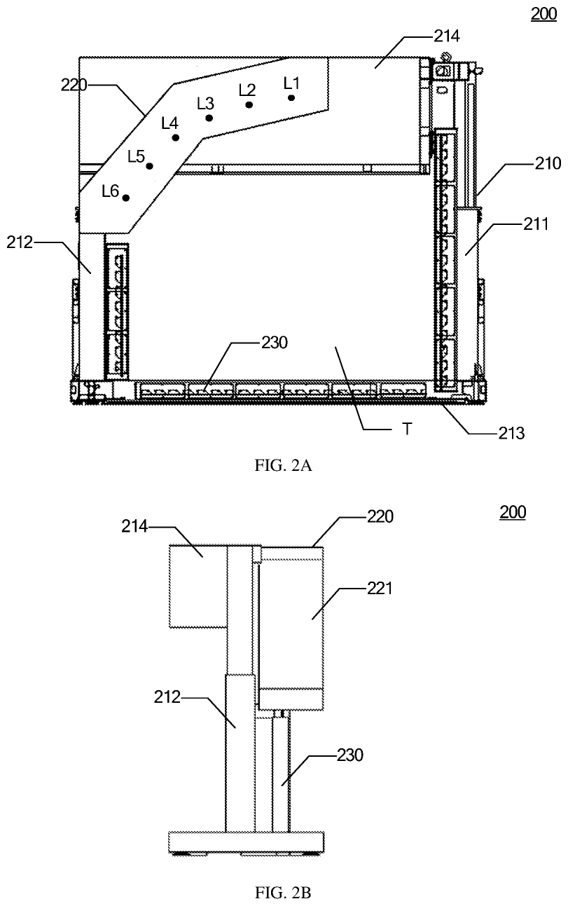

FIG. 2A schematically shows a schematic front view of an object detection device 200 according to the embodiments of the present disclosure.

FIG. 2B schematically shows a schematic left view of the object detection device 200 shown in FIG. 2A.

As shown in FIG. 2A and FIG. 2B, the object detection device 200 may includes a support structure 210, a ray source assembly 220 and a detector assembly 230. The support structure 210 is configured to form a passageway T for a passage of a detected object. The ray source assembly 220 is configured to emit a ray. The detector assembly 230 includes a detector mounting frame connected to the support structure 210 and a plurality of detection units arranged on the detector mounting frame, and the detection units are configured to receive a transmission ray penetrating the detected object and obtain a detection information based on the transmission ray.

For example, the support structure 210 includes a vertical support arm, and the vertical support arm may include, for example, a first support arm 211 and a second support arm 212 located on two sides of the passageway T. In addition, the support structure 210 may further include a transverse support 213 at a bottom portion and a transverse structure 214 at a top portion.

According to the embodiments of the present disclosure, a height of the vertical support arms of the support structure is adjustable. A vertical distance from the ray source assembly 220 to the bottom portion of the support structure varies with the height of the vertical support arm.

For example, the first support arm 211 and the second support arm 212 may be telescopic structures. When the first support arm 211 and the second support arm 212 are shortened, the height of the ray source assembly 220 relative to the bottom portion of the support structure will also decrease accordingly, and a volume of the entire device is reduced, which is convenient for movement and transportation. When the first support arm 211 and the second support arm 212 are elongated, the height of the ray source assembly 220 relative to the bottom portion of the support structure will also increase accordingly, and the height of the entire device will increase, so that the detected object may pass through the passageway.

According to the embodiments of the present disclosure, the object detection device may meet the needs of convenient transportation and fast field transition, so that the object detection device may be used in different places. The object detection device may be folded during transportation to facilitate movement and transportation, and it may be unfolded during use, so that the device is more flexible and mobile.

In some cases, an object inspection system needs to be transported to different places for detection, which requires the object inspection system to be small in size. However, a small object detection device does not have enough space to install a large number of ray sources and detectors needed for a multi-view detection, and therefore it may not meet the needs of multi-view detection. In order to meet the needs of a multi-view detection and a convenient transportation at the same time, according to another embodiment of the present disclosure, there is provided an object detection device that may both provide a multi-view transmission imaging and may achieve a fast field transition.

The object detection device may include the support structure, the ray source assembly and the detector assembly as described above. The ray source assembly 220 may include a ray source cabin 221 connected to the support structure 210 and a ray source located in the ray source cabin 221. The ray source cabin 221 has a plurality of emission positions, the ray source is configured to sequentially emit a ray from the plurality of emission positions to the detected object in the passageway, and centerlines of rays emitted from any two of the plurality of emission positions form an included angle to perform a multi-view transmission on the detected object.

For example, the ray source cabin 221 may be connected to the transverse structure 214 on the top. The ray source cabin has a plurality of emission positions, for example, six emission positions L1-L6 shown in FIG. 2A. The plurality of emission positions are respectively located in different directions of the passageway T, for example, they are continuously and evenly distributed on an arc line from the top to a side of the passageway T.

As shown in FIG. 1A and FIG. 2A, the ray source is configured to sequentially emit a ray from the plurality of emission positions L1-L6 to the detected object in the passageway T, so as to perform a multi-view transmission on the detected object. For example, a ray is emitted from the emission position L1, a ray emission from the emission position L1 is stopped after a predetermined period, then a ray is emitted from the emission position L2, this proceeds in a similar manner, until a ray is emitted from the emission position L6, and a ray emission is stopped after a predetermined period, thereby completing one scanning of a corresponding section. During a slow passage of the detected object through the passageway, the ray source emits a ray from the plurality of emission positions L1-L6 in turn to complete a scanning on front and rear sections of the detected object. The ray source cabin 221 is provided with an exit port corresponding to each emission position, so that a ray may enter the passageway T from the exit port. Centerlines of rays emitted from any two emission positions of the plurality of emission positions form an included angle, i.e., centerlines of rays emitted from any two emission positions of the plurality of emission positions are not parallel, so as to achieve a multi-view detection on the object. In the embodiments of the present disclosure, the rays may be, for example, X-rays.

FIG. 3 schematically shows a schematic diagram of a ray beam emitted from an emission position L1 according to the embodiments of the present disclosure.

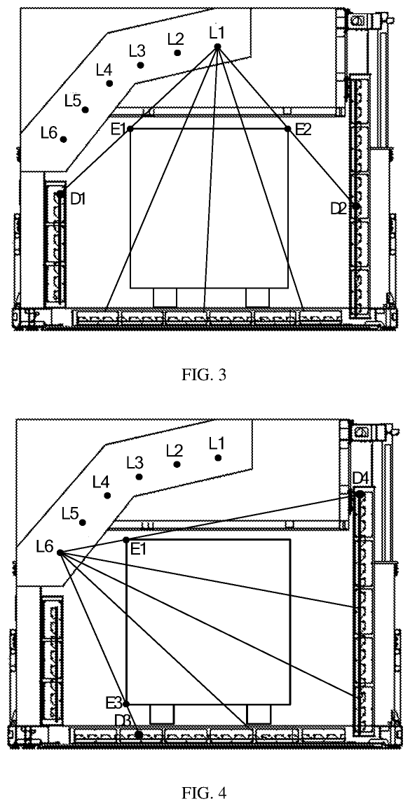

FIG. 4 schematically shows a schematic diagram of a ray beam emitted from an emission position L6 according to the embodiments of the present disclosure.

As shown in FIG. 3 and FIG. 4, the ray beam emitted from each emission position may be fan-shaped and may cover an entire region of the detected object. For example, a region between a connecting line from the emission position L1 to one side edge E1 of the detected object and a connecting line from the emission position L1 to the other side edge E2 of the detected object is located within a radiation range of the ray beam emitted by the emission position L1. Similarly, a region between a connecting line from the emission position L6 to the edge E1 of the detected object and a line connecting from the emission position L6 to an edge E3 is located within a radiation range of the ray beam emitted by the emission position L6. According to the embodiments of the present disclosure, the detection units used for the ray emitted from each emission position are also different. For example, the ray beam emitted from the emission position L1 at least corresponds to the detection units between a position D1 and a position D2. The ray beam emitted from the emission position L6 at least corresponds to the detection units between a position D3 and a position D4.

According to the embodiments of the present disclosure, as the ray source sequentially emits a ray from the plurality of emission positions, the detection unit may also sequentially receive the ray emitted from different emission positions, and the detection unit may be time-division multiplexed. For example, when a ray is emitted from the emission position L1, a plurality of detection units may be used to receive a transmission ray after the ray emitted from the emission position L1 penetrates the detected object, and obtain a detection information from a viewing angle of the emission position L1. When a ray is emitted from the emission position L6, a plurality of detection units may be used to receive a transmission ray after the ray emitted from the emission position L6 penetrates the detected object, and obtain a detection information from a viewing angle of the emission position L6. Then, when the detected object passes through the passageway, an imaging algorithm may be used to obtain a transmission image at a corresponding viewing angle according to the detection information at each viewing angle. For example, a top view image and several side view (such as L5 and L6) images of the detected object may be obtained.

According to the embodiments of the present disclosure, the object detection device may not only achieve a multi-view transmission imaging, but also meet the requirements of convenient transportation and fast field transition. It may provide multiple detection images from different angles, so that the problem of omission caused by overlapping objects in a single viewing angle is avoided, and the identification of specific objects may be improved.

According to the embodiments of the present disclosure, the ray source may be a movable ray source configured to sequentially move to a plurality of emission positions and emit a ray. For example, only one ray source device may be provided in the ray source cabin 221. The ray source device is controlled to sequentially move from the emission position L1 to the emission position L6 during the detection process, and emits a ray towards the detected object when reaching each emission position. For example, a driving mechanism may also be provided in the ray source cabin. The driving mechanism is connected to the ray source device and may drive the ray source device to move, wherein the driving mechanism may be, for example, an electric sliding rail mechanism. In the embodiments of the present disclosure, the movable ray source may be, for example, an accelerator, an X-ray machine, an isotope ray source, etc., and the movable ray source may be an independent ray source or a distributed ray source.

According to another embodiment of the present disclosure, the ray source may be a distributed ray source. The distributed ray source includes a plurality of emission units corresponding to the plurality of emission positions one to one, and the plurality of emission units are configured to sequentially emit a ray. For example, the distributed ray source may include six emission units, and the six emission units respectively correspond to the corresponding emission positions L1-L6. During the detection, the six ray source devices are controlled to sequentially emit rays to the detected object in a time sequence.

For example, a distributed ray source may include an electron source and an anode part, and the electron source may have a plurality of electron emission regions, so as to emit an electron beams at different positions of the electron source. The anode part is arranged corresponding to the electron source. A surface where a target material of the anode part is located opposite to a surface where an electron beam is emitted by the electron source. An electron beam generated by each electron emission region respectively generates one X-ray target point at a different position of the anode part, and the X-ray target point generates an X-ray. Such an X-ray source that generates a plurality of X-ray target points at different positions of the anode may be called a distributed X-ray source. According to another embodiment of the present disclosure, the ray source may include a plurality of independent ray sources, the plurality of independent ray sources are respectively arranged at a plurality of emission positions, and the plurality of independent ray sources are configured to sequentially emit rays. In this embodiment, a ray source for an independent emission is provided at each emission position, and each ray source may emit one beam of X-ray.

In another embodiment of the present disclosure, the ray source may include a plurality of independent ray sources, the plurality of independent ray sources are respectively arranged at a plurality of emission positions, and the plurality of independent ray sources are configured to sequentially emit a ray. In this embodiment, a ray source for an independent emission is provided at each emission position, and each ray source may emit one beam of X-ray. Here, the independent ray source may be, for example, an accelerator, an X-ray machine, an isotope light source, etc.

According to the embodiments of the present disclosure, the object detection device further includes a controller and a processor. The controller may be, for example, a controller arranged on the support structure. The controller is used to control the ray source to sequentially emit a ray to the detected object at the plurality of emission positions, and control the plurality of detection units to sequentially obtain a detection information corresponding to the ray emitted from each emission position. The processor may be a processor arranged on the support structure. The processor may be, for example, a general-purpose microprocessor, an instruction set processor and/or a related chipset and/or a special-purpose microprocessor, etc. In addition, the processor may also be a data processing computer located at backend. The processor is connected to the detection unit, may obtain the detection information of the detection unit, and may obtain a scanned image at a viewing angle corresponding to each emission position according to the detection information.

The processor may also perform a three-dimensional reconstruction processing on the scanned image at a viewing angle corresponding to each emission position to obtain a three-dimensional image. The three-dimensional image may improve the identification of specific objects and enable an inspector to quickly identify the specific objects. Here, if images of the detected object at partial viewing angles may only be obtained, for example, images at the top view and several side views may only be obtained, a partial 3D reconstruction may be performed to reconstruct 3D images of partial regions. In a case that a number of viewing angles is large enough, a conventional algorithm such as filtered back projection reconstruction (FBP) or algebraic iterative reconstruction (ART) may be used for a 3D reconstruction. In a case that the number of viewing angles does not meet the requirements for a complete reconstruction, algorithms such as a sparse angle reconstruction and a finite angle reconstruction may be used.

According to the embodiments of the present disclosure, the plurality of emission positions are distributed in a plane perpendicular to a travelling direction defined by the passageway. The ray source is arranged so that the rays emitted at the plurality of emission positions are all coplanar with the plurality of detection units, and in this way the rays may be accurately incident the detection units after penetrating the detected object.

According to the embodiments of the present disclosure, a connecting line of the plurality of emission positions is in an arc shape or a zigzag shape, wherein a vertical distance from an emission position at a first end to a bottom portion of the support structure is greater than a vertical distance from an emission position at a second end to the bottom portion of the support structure.

For example, a connecting line of the emission positions L1-L6 may be in an arc shape, and a central angle corresponding to the arc shape may be, for example, 60°. A height of the emission position L1 is greater than a height of the emission position L6. The heights of the emission positions L1-L6 may be for example sequentially lowered, so that rays emitted from partial emission positions of the plurality of emission positions may at least be incident at a top portion of the detected object, and rays emitted from partial emission positions thereof may at least be incident at a side edge of the detected object.

The ray source assembly is located in a corner area of the support structure and is near a top portion and a second side portion of the support structure (the second side portion may be, for example, a left side portion of an orientation shown in FIG. 3 and FIG. 4). For example, the ray source cabin may be arranged in an apical angle area of the support structure.

According to the embodiments of the present disclosure, the ray source is configured so that rays emitted from partial emission positions of the plurality of emission positions may at least be incident at the top portion of the detected object, and rays emitted from partial emission positions of the plurality of emission positions may at least be incident at a second side edge of the detected object. For example, a ray emitted from the emission position L1 may be incident at the top portion of the detected object, a ray emitted from the emission position L4 may be incident at the top portion and the side portion of the detected object, and a ray emitted from the emission position L6 may be incident at the second side edge of the detected object.

Based on the above embodiments, images at a plurality of continuous viewing angles from a top view angle, an oblique view angle and then to a side view angle may be obtained, which further improves the identification of specific objects and facilitates a 3D reconstruction.

Referring to FIG. 2A and FIG. 2B again, according to the embodiments of the present disclosure, the vertical support arm includes a first support arm 211 and a second support arm 212, and the first support arm 211 and the second support arm 212 are both telescopic structures. The support structure further includes a transverse cabin 214 connected between the first support arm 211 and the second support arm 212, that is, the transverse structure 214 may be embodied as a cabin. Two sides of the transverse cabin 214 are respectively connected to the first support arm 211 and the second support arm 212, and the ray source cabin 221 is connected to the transverse cabin 214. Specifically, the ray source cabin 221 may be arranged on a front side of the transverse cabin 214.

According to the embodiments of the present disclosure, the transverse cabin 214 may be configured to house a cooling device and a controller, wherein the cooling device is configured to cool the ray source, and the controller is at least configured to control the ray source. The cooling device may cool the ray source by means of oil cooling.

According to the embodiments of the present disclosure, the ray source cabin is mounted on the transverse cabin of the support structure, and the cooling device and the controller of the ray source are arranged in the transverse cabin. This not only achieves support for the ray source cabin, but also achieves a reasonable setting of the cooling device and the controller of the ray source, thereby reducing the structural complexity of the ray source cabin.

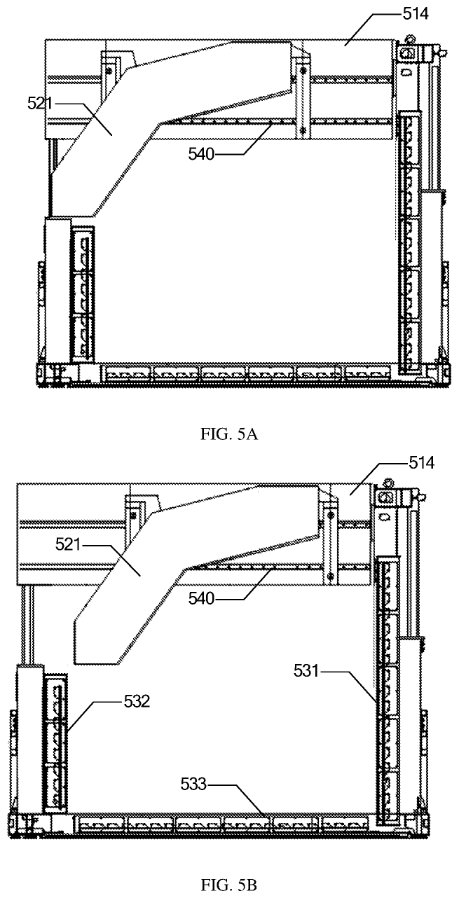

FIG. 5A schematically shows a schematic view of a ray source cabin 521 in a first position according to the embodiments of the present disclosure.

FIG. 5B schematically shows a schematic view of the ray source cabin 521 in a second position according to the embodiments of the present disclosure.

As shown in FIG. 5A and FIG. 5B, according to the embodiments of the present disclosure, the ray source cabin 521 is configured to move along an extending direction of the transverse cabin 514. For example, the ray source cabin 521 is connected to the transverse cabin 514 through a guide rail 540, and the ray source cabin 521 may slide transversely along the guide rail 540. Based on this solution, when in a detection state, the ray source cabin 521 may be positioned to one side, for example, to a left side as shown in FIG. 5A, so as to avoid the passageway to allow the detected object to pass through, and when a transport is needed, the ray source cabin 521 may be first moved to a middle portion, and then the heights of the support arms on two sides are lowered to avoid interference between the ray source cabin 521 and the detector mounting frame at a lower portion during the lowering process.

As shown in FIG. 5B, according to the embodiments of the present disclosure, the detector mounting frame may include a transverse mounting frame 533 and a vertical mounting frame. The vertical mounting frame includes a first vertical mounting frame 531 and a second vertical mounting frame 532 respectively arranged on two sides of the transverse mounting frame 533. The detector mounting frame is divided into three segments. This may meet the requirements of receiving rays emitted from the plurality of emission positions, so that rays within an angle range of ray beams emitted from various emission positions are all received by the detection units, and the mounting frame at the bottom portion does not need to extend for a long distance, thereby reducing a transverse width of the device.

According to the embodiments of the present disclosure, in the case that the ray source assembly is located at the corner area of the support structure and is close to the top portion and the second side portion of the support structure, a length of the first vertical mounting frame 531 close to a first side portion of the support structure may be greater than a length of the second vertical mounting frame 532 close to the second side portion of the support structure.

The detection unit on the detector mounting frame may receive rays passing through each apical angles of the detected object, and then may cover any beam of ray passing through the object. For example, as shown in FIG. 5B and FIG. 3, an intersection point D1 between a connecting line of the emission position L1 and an edge E1 of the object and the second vertical mounting frame 532 is not higher than the detection unit on the top portion of the second vertical mounting frame 532, so that the detection unit on the second vertical mounting frame 532 may receive a ray at the edge. In order to reduce the volume of the device as much as possible, the detection unit on the top portion of the second vertical mounting frame 532 may be located exactly on the connecting line of the emission position L1 and the edge E1 of the object, so that the second vertical mounting frame 532 may receive a ray at the edge, and also have a smaller height. Similarly, as shown in FIG. 5B and FIG. 4, the detection unit on the top portion of the first vertical mounting frame 531 may be located exactly on the connecting line of the emission position L6 and the edge E1 of the object.

According to the embodiments of the present disclosure, at least one of the first vertical mounting frame 531 and the second vertical mounting frame 532 has a height adjustable; or at least one of the first vertical mounting frame 531 and the second vertical mounting frame 532 has a height variable with the height of the vertical support arm. Based on this solution, in the process of changing to the transportation state, the heights of the detector mounting frames on two sides may be reduced, so as to avoid the problem that the overall height of the device may not be further reduced due to excessively long lengths of the detector mounting frames.

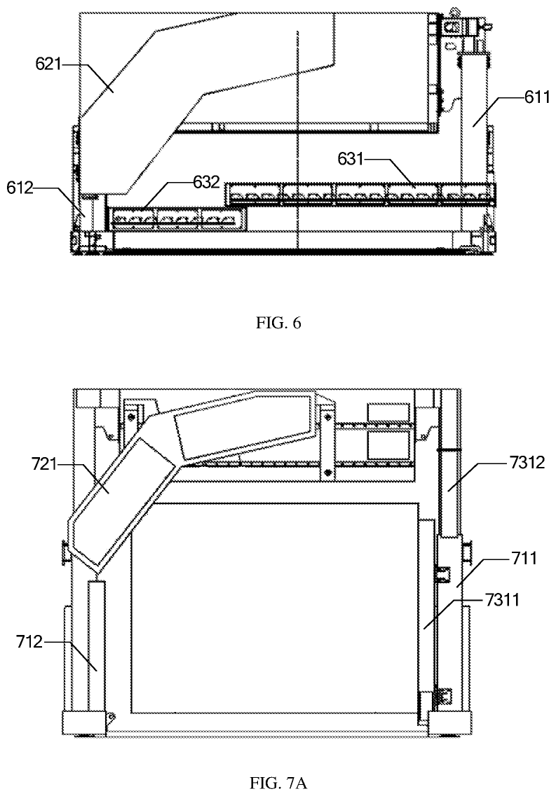

FIG. 6 schematically shows a schematic view of a first vertical mounting frame and a second vertical mounting frame in a lowered state according to the embodiments of the present disclosure.

As shown in FIG. 6, according to the embodiments of the present disclosure, the vertical support arm includes a first support arm 611 connected to the first vertical mounting frame 631 and a second support arm 612 connected to the second vertical mounting frame 632. Here, a bottom portion of the first vertical mounting frame 631 is rotatably connected to a bottom portion of the first support arm 611, and the first vertical mounting frame 631 is configured to rotate around the bottom portion of the first support arm 611, so as to adjust a height of the first vertical mounting frame 631; and/or a bottom portion of the second vertical mounting frame 632 is rotatably connected to a bottom portion of the second support arm 612, and the second vertical mounting frame 632 is configured to rotate around the bottom portion of the second support arm 612, so as to adjust a height of the second vertical mounting frame 632.

For example, only the first vertical mounting frame 631 may be set to be in a rotatable connection form, or only the second vertical mounting frame 632 may be set to be in a rotatable connection form, or the first vertical mounting frame 631 and the second vertical mounting frame 632 may be both set to be in a rotatable connection form. The vertical mounting brackets 632 are all arranged in a rotatable connection form. In the third case, when transportation is needed, the first vertical mounting frame 631 and the second vertical mounting frame 632 may be both brought down, and then the ray source cabin 621 is directly lowered. That is, as the second vertical mounting frame 632 is already in a horizontal state, and the ray source cabin 621 does not need to be moved to the middle portion, so that the ray source cabin 621 may be directly lowered without interfering with the second vertical mounting frame 632.

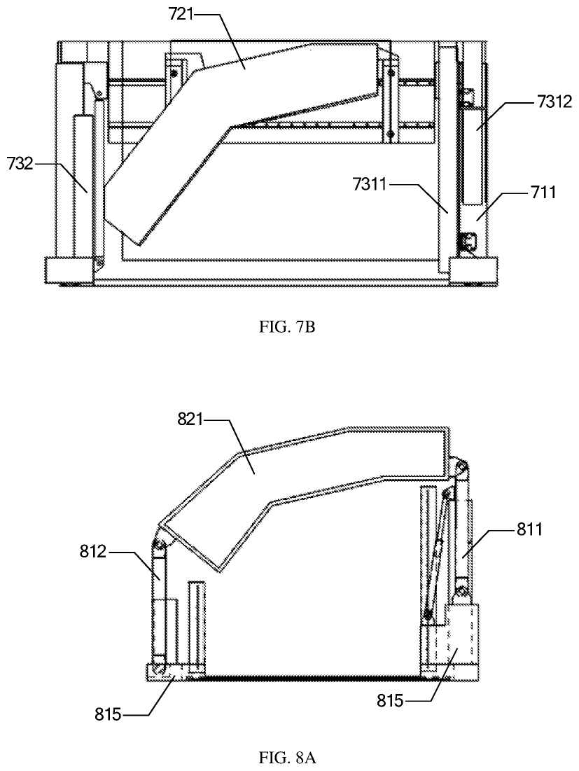

FIG. 7A schematically shows a schematic view of an object detection device according to another embodiment of the present disclosure.

FIG. 7B schematically shows a schematic view of a first vertical mounting frame in a lowered state according to another embodiment of the present disclosure.

As shown in FIG. 7A and FIG. 7B, according to the embodiments of the present disclosure, the first support arm 711 includes a first support segment and a second support segment telescopic relative to the first support segment. For example, the first support arm 711 may be a telescopic structure, the first support segment is in a fixed position, and the second support segment may be moved up and down relative to the first support segment to achieve an expansion and contraction of the first support arm 711. The first support segment may be located below the second support segment.

The first vertical mounting frame may also be divided into two segments, such as a first mounting segment 7311 and a second mounting segment 7312. The first mounting segment 7311 may be fixedly connected to the first support segment, and the second mounting segment 7312 may be fixedly connected to the second mounting segment 7312, so that a length of the first vertical mounting frame varies with the expansion and contraction of the second support segment. For example, when the second support segment moves downward, it may drive the second mounting segment 7312 to move downward together, and the overall height of the first vertical mounting frame is decreased; and when the second support segment moves upward, it may drive the second mounting segment 7312 to move upward together, and the overall height of the first vertical mounting frame is increased.

In a case that the length of the second vertical mounting frame 732 is small, the second vertical mounting frame 732 does not need to be set in a segmented structure and the second vertical mounting frame 732 does not need to be brought down, either. However, in order to avoid interference of the ray source cabin 721 with the second vertical mounting frame 732, the ray source cabin 721 may be first moved to the middle portion of the device, and then the height of the ray source cabin 721 may be reduced.

Based on the above embodiments, the first vertical mounting frame may be folded or unfolded during the contraction or expansion process of the first support arm. This may speed up the efficiency of device state transition to achieve a quick entrance into the transportation state or the use state.

According to the embodiments of the present disclosure, the first support segment and the second support segment may be provided with a guide structure for defining a moving direction of the second support segment. For example, the first support segment may be provided with a guide groove extending along the length thereof, the second support segment may be provided with a guide block, and the guide block may slide along the guide groove, so as to guide the moving direction of the second support segment. In addition, a hydraulic drive or an electric drive may be used to drive the second support segment to move up and down relative to the first support segment.

According to the embodiments of the present disclosure, the first support segment and/or the second support segment may be provided with a locking device for restricting a movement of the second support segment after the second support segment moves to a set position of the first support segment. For example, the first support segment may be provided with a locking bolt. When the second support segment rises to a specified position, the locking bolt may be rotated to make it abut against a surface of the second support segment, and a relative position between the first support segment and the second support segment may be fixed by a frictional force. Alternatively, a connection hole may be provided on the second support segment. When the second support segment rises to a specified position, the locking bolt may be rotated to make it extend into the connection hole of the second support segment, thereby fixing the relative position between the first support segment and the second support segment.

According to another embodiment of the present disclosure, the vertical support arm of the object detection device includes a first support arm and a second support arm, and the ray source assembly is connected between the first support arm and the second support arm. Different from the above embodiments, two sides of the ray source cabin may be directly connected to the first support arm and the second support arm.

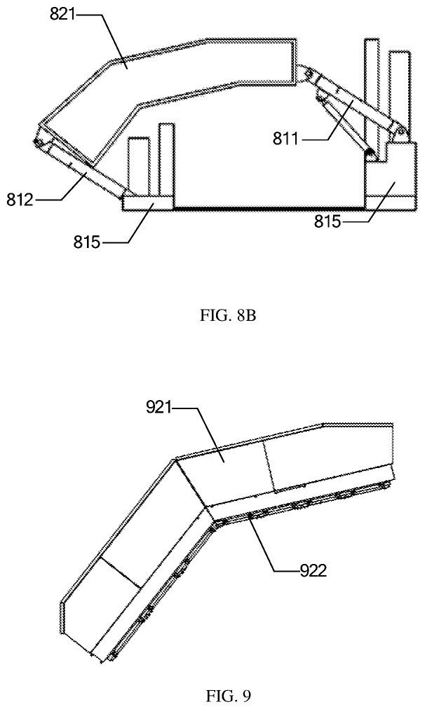

FIG. 8A and FIG. 8B schematically show a schematic view of an object detection device according to another embodiment of the present disclosure.

As shown in FIG. 8A and FIG. 8B, two sides of the ray source cabin 821 may be directly connected to the first support arm 811 and the second support arm 812. In addition, the support structure may further include a base seat 815 connected to the first support arm and the second support arm. The first support arm 811 and the second support arm 812 are both configured to rotate relative to the base seat 815, and during the rotation of the first support arm 811 and the second support arm 812 relative to the base seat 815, the height of the ray source assembly varies.

For example, the first support arm 811, the second support arm 812, the ray source cabin 821 and the base seat 815 may form a four-linkage mechanism. During the rotation of the first support arm 811 and the second support arm 812, the ray source cabin 821 deflects accordingly and the height varies.

According to the embodiments of the present disclosure, the first support arm and the second support arm may also be configured as telescopic structures. During the expansion and contraction process of the first support arm and the second support arm, the height of the ray source assembly varies.

FIG. 9 schematically shows a schematic view of a ray source assembly according to the embodiments of the present disclosure.

As shown in FIG. 9, according to the embodiments of the present disclosure, the ray source assembly further includes a collimator 922. The collimator 922 is located on a side of a ray emission of the ray source cabin 921, and the collimator 922 is used to adjust a ray emitted from the plurality of emission positions. For example, it may be used to constrain a width of a ray and ensure that the ray is accurately incident on the detection unit. Here, a width of a ray may refer to a dimension of a ray beam in the travelling direction of the detected object, and the collimator 922 may be close to a lower portion of the ray source cabin 921, the collimator 922 may constrain a ray emitted by each ray source in the traveling direction of the detected object, so that rays emitted by different ray sources all fall on a plane constituted by the transverse mounting frame and the vertical mounting frame of the detector.

According to the embodiments of the present disclosure, the ray source may be a distributed ray source. The distributed ray source uses an electron beam to bombard each target point to generate an X-ray. For the distributed ray source, a certain linearity problem exists on different target points themselves, and the ray source may not be adjusted. In this case, the collimator may be a segmented collimator. Each segment of the collimator may correspond to one emission position. A parameter of each segment of the collimator may be adjusted separately, for example, a collimating slit of a corresponding collimator may be adjusted separately for a beam emitted from a different target point.

According to another embodiment of the present disclosure, the ray source may include a plurality of independent ray sources, the collimator is an integral collimator, and parameters of the integral collimator are uniformly adjusted. For example, the independent ray source may be an accelerator, an X-ray machine, an isotope light source, etc., and each independent ray source may adjust the position and angle independently. That is, the position of each ray source may be adjusted within the ray source cabin. In this case, an integral collimator may be used to perform an overall constraint to the width of each ray beam, and filter out redundant rays in each ray beam.

According to the embodiments of the present disclosure, the object detection device may further include a conveying device. The conveying device may be connected to the bottom portion of the support structure and configured to convey the detected object to pass through the passageway. For example, the conveying device may be a conveyor set to convey the detected object along a travelling direction defined by the passageway. In addition, the conveying device may also be an automatic navigation transport vehicle or the like.

According to the embodiments of the present disclosure, the object detection device may further include an anti-collision sensor. The anti-collision sensor may be arranged on the vertical support arm and configured to detect a distance between the detected object and the vertical support arm. For example, the distance between the detected object and the vertical support arms on two sides may be monitored. The controller is further configured to: control the conveying device, the ray source and the plurality of detection units according to the distance between the detected object and the vertical support arm. For example, in a case that the distance between the detected object and the vertical support arm is less than a safety distance, the conveying device may be controlled to stop conveying the detected object, and the ray source and the detection unit may be controlled to stop working. Based on this solution, the detected object may be prevented from colliding with the object detection device during the detection process. In another embodiment, if the detected object is a vehicle, the vehicle may be driven by a driver to pass through the passageway, and when the distance between the vehicle and the vertical support arm is less than the safe distance, an alarm device may be used to warn the driver.

According to the embodiments of the present disclosure, the object detection device may further include a collection device configured to collect an identification information of the detected object. The processor is further configured to: establish a corresponding relationship between the identification information of the detected object and the scanned image.

For example, an image collection device may be used to collect a license plate image of a vehicle, the processor may be used to identify the license plate image and obtain a license plate information, and then the license plate information may be bound with a scanned image of the vehicle for a subsequent search and lookup for a needed scanned image.

According to the embodiments of the present disclosure, the processor is further configured to: determine one target detection mode from a plurality of preset detection modes according to a current detection portion of the detected object, and perform a detection on the detected object based on the target detection mode. Here, in different detection modes, different numbers of emission positions are used to emit a ray; in a first scanning mode of a plurality of scanning modes, a single emission position of the plurality of emission positions is used to emit a ray; in a second scanning mode of the plurality of scanning modes, the plurality of emission positions are used to emit a ray.

For example, a vehicle may include a cab portion and a packing case portion. When the cab portion moves to the plane where the ray source is located, one or a small number of emission positions may be used to emit a ray to avoid a damage to the driver. When the packing case portion moves to the plane where the ray source is located, the plurality of emission positions may be used to emit rays to detect the packing case from a plurality of view angles. Alternatively, when the cab passes a scanning plane, a scanning may not be performed, and a multi-view scanning is performed on the packing case after the cab is avoided. Alternatively, before the detection, the driver may be let out of the vehicle, and then the vehicle may be transported to pass through the passageway by the conveying device. In this case, a multi-view detection may be performed on the entire vehicle.

According to the embodiments of the present disclosure, the processor is further configured to: determine one or more target emission positions from the plurality of emission positions according to a user instruction. The controller is further configured to: control the ray source to sequentially emit a ray to the detected object at one or more target emission positions.

For example, an inspector may specify which emission positions to use to emit rays. Referring to FIG. 2A, if the inspector only wants to detect an image at a top view of the object, the emission positions L1 and L2 may be pre-selected for scanning, and the controller may control the ray source to sequentially emit rays at emission positions L1 and L2.

According to the embodiments of the present disclosure, the object detection device may further include two protective baffles.

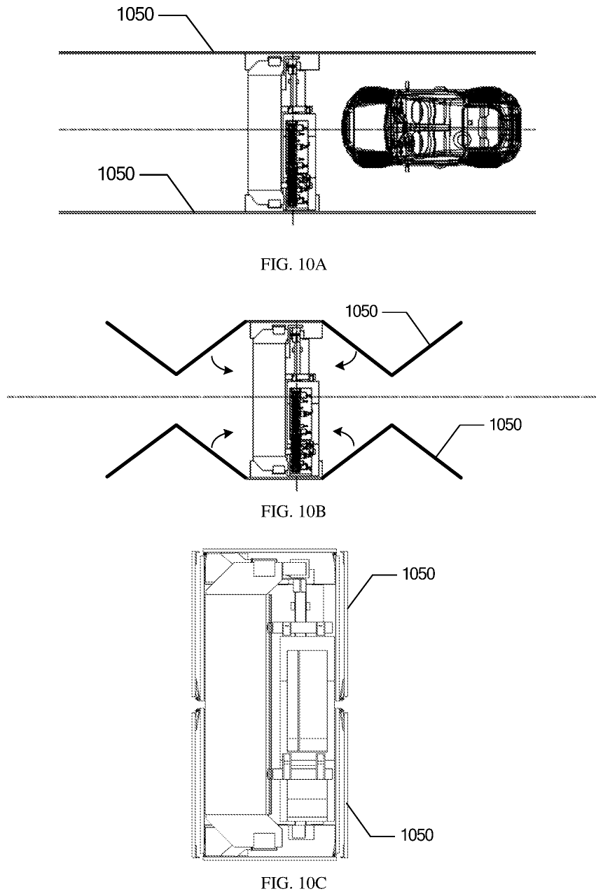

FIG. 10A, FIG. 10B and FIG. 10C schematically show schematic views of a protective baffle according to the embodiments of the present disclosure.

As shown in FIG. 10A, FIG. 10B and FIG. 10C, two protective baffles 1050 are respectively connected to two sides of the support structure, and the protective baffles 1050 have an unfolded state and a folded state. Here, FIG. 10A shows a schematic view of the protective baffle 1050 in the unfolded state. In a case that the protective baffle is in the unfolded state, both protective baffles extend along the travelling direction defined by the passageway, which may protect the personnel on two sides. FIG. 10B shows a schematic view of the protective baffle 1050 changing from the unfolded state to the folded state, and FIG. 10C shows a schematic view of the protective baffle 1050 in the folded state. In a case that the protective baffle is in the folded state, both protective baffles 1050 are folded to two sides of the passageway, so that the volume of the entire device is reduced, and then the device may be put into a container or truck for transportation and transition.

According to another aspect of the embodiments of the present disclosure, there is provided another object detection device. The object detection device may include a ray source assembly, a detector assembly, and a controller.

Here, the ray source assembly includes a ray source cabin and a ray source located in the ray source cabin, the ray source cabin having a plurality of emission positions. The detector assembly includes a detector mounting frame and a plurality of detection units arranged on the detector mounting frame, wherein the detector mounting frame includes a transverse mounting frame and a first vertical mounting frame and a second vertical mounting frame respectively arranged on two sides of the transverse mounting frame. The transverse mounting frame, the first vertical mounting frame and the second vertical mounting frame are all provided with detection units. The controller is configured to control the ray source to sequentially emit a ray from the plurality of emission positions, and control the detection units to sequentially receive a ray emitted from each emission position of the plurality of emission positions, wherein centerlines of rays emitted from any two emission positions of the plurality of emission positions form an included angle.

Specifically, FIG. 2A, FIG. 3 and FIG. 4 may be referred to for the ray source assembly and the detector assembly. For example, the ray source cabin may have six emission positions L1-L6, and the plurality of emission positions are respectively in different orientations of the passageway of the object. The ray source is configured to sequentially emit a ray from the plurality of emission positions L1-L6 to the detected object in the passageway, so as to perform a multi-view transmission on the detected object. For example, a ray is first emitted from the emission position L1, a ray emission from the emission position L1 is stopped after a predetermined period, then a ray is emitted from the emission position L2, this proceeds in a similar manner, until a ray is emitted from the emission position L6, and a ray emission is stopped after a predetermined period, thereby completing one scanning of a corresponding section. During a slow passage of the detected object through the passageway, the ray source emits a ray from the plurality of emission positions L1-L6 in turn to complete a scanning on front and rear sections of the detected object. Here, centerlines of rays emitted from any two emission positions of the plurality of emission positions form an included angle, i.e., centerlines of rays emitted from any two emission positions of the plurality of emission positions are not parallel, so as to achieve a multi-view detection on the object. In the embodiments of the present disclosure, the rays may be, for example, X-rays.

The ray beam emitted from each emission position may be fan-shaped and may cover an entire region of the detected object. For example, a region between a connecting line from the emission position L1 to one side edge of the detected object and a connecting line from the emission position L1 to the other side edge of the detected object is located within a radiation range of the ray beam emitted by the emission position L1. According to the embodiments of the present disclosure, the detection units used for the ray emitted from each emission position are also different.

According to the embodiments of the present disclosure, the detector mounting frame may include a transverse mounting frame and a vertical mounting frame. The vertical mounting frame includes a first vertical mounting frame and a second vertical mounting frame respectively arranged on two sides of the transverse mounting frame. Bottom portions of the first vertical mounting frame and the second vertical mounting frame may be connected to the transverse mounting frame. The detection unit on the detector mounting frame may receive rays passing through each apical angles of the detected object, and then may cover any beam of ray passing through the object.

The detector mounting frame is divided into three segments. This may meet the requirements of receiving rays emitted from the plurality of emission positions, so that rays within an angle range of ray beams emitted from various emission positions are all received by the detection units, and the mounting frame at the bottom portion does not need to extend for a long distance, thereby reducing a transverse width of the device. According to the embodiments of the present disclosure, as the ray source sequentially emits a ray from the plurality of emission positions, the detection unit may be controlled to sequentially receive the ray emitted from different emission positions, and the detection unit may be time-division multiplexed. For example, when a ray is emitted from the emission position L1, a plurality of detection units may be used to receive a transmission ray after the ray emitted from the emission position L1 penetrates the detected object, and obtain a detection information from a viewing angle of the emission position L1. When a ray is emitted from the emission position L6, a plurality of detection units may be used to receive a transmission ray after the ray emitted from the emission position L6 penetrates the detected object, and obtain a detection information from a viewing angle of the emission position L6. Then, when the detected object passes through the passageway, an imaging algorithm may be used to obtain a transmission image at a corresponding viewing angle according to the detection information at each viewing angle. For example, a top view image and several side view (such as L5 and L6) images of the detected object may be obtained.

According to the embodiments of the present disclosure, the ray source is configured as one of the following: (1) the ray source is a movable ray source, and the movable ray source is configured to be sequentially moved to the plurality of emission positions and emit a ray; (2) the ray source is a distributed ray source, the distributed ray source includes a plurality of emission units corresponding to the plurality of emission positions one to one, and the plurality of emission units are configured to sequentially emit a ray; and (3) the ray source includes a plurality of independent ray sources, the plurality of independent ray sources are respectively arranged at the plurality of emission positions, and the plurality of independent ray sources are configured to sequentially emit a ray.

In one embodiment of the present disclosure, only one ray source device may be provided in the ray source cabin. The ray source device is controlled to sequentially move from the emission position L1 to the emission position L6 during the detection process, and emits a ray towards the detected object when reaching each emission position. For example, a driving mechanism may also be provided in the ray source cabin. The driving mechanism is connected to the ray source device and may drive the ray source device to move, wherein the driving mechanism may be, for example, an electric sliding rail mechanism. In the embodiments of the present disclosure, the movable ray source may be, for example, an accelerator, an X-ray machine, an isotope ray source, etc., and the movable ray source may be an independent ray source or a distributed ray source.

In another embodiment of the present disclosure, the ray source may be a distributed ray source. The distributed ray source includes a plurality of emission units, for example, includes six emission units. The six emission units respectively correspond to the corresponding six emission positions L1-L6. During the detection, the six ray source devices are controlled to sequentially emit rays to the detected object in a time sequence.

For example, a distributed ray source may include an electron source and an anode part, and the electron source may have a plurality of electron emission regions, so as to emit an electron beams at different positions of the electron source. The anode part is arranged corresponding to the electron source. A surface where a target material of the anode part is located opposite to a surface where an electron beam is emitted by the electron source. An electron beam generated by each electron emission region respectively generates one X-ray target point at a different position of the anode part, and the X-ray target point generates an X-ray. Such an X-ray source that generates a plurality of X-ray target points at different positions of the anode may be called a distributed X-ray source.

In another embodiment of the present disclosure, the ray source may include a plurality of independent ray sources, the plurality of independent ray sources are respectively arranged at a plurality of emission positions, and the plurality of independent ray sources are configured to sequentially emit rays. In this embodiment, a ray source for an independent emission is provided at each emission position, and each ray source may emit one beam of X-ray. Here, the independent ray source may be, for example, an accelerator, an X-ray machine, an isotope light source, etc.

According to the embodiments of the present disclosure, a connecting line of the plurality of emission positions is in an arc shape or a zigzag shape, wherein a vertical distance from an emission position at a first end to a bottom portion of the object detection device is greater than a vertical distance from an emission position at a second end to the bottom portion of the object detection device.

For example, a connecting line of the emission positions L1-L6 may be in an arc shape. A height of the emission position L1 is greater than a height of the emission position L6. The heights of the emission positions L1-L6 may be for example sequentially lowered, so that rays emitted from partial emission positions of the plurality of emission positions may at least be incident at a top portion of the detected object, and rays emitted from partial emission positions thereof may at least be incident at a side edge of the detected object.

According to the embodiments of the present disclosure, the bottom portions of the first vertical mounting frame and the second vertical mounting frame are connected to the transverse mounting frame. The vertical distance from the top portion of the first vertical mounting frame to the transverse mounting frame is greater than the vertical distance from the top portion of the second vertical mounting frame to the transverse mounting frame. The first vertical mounting frame is close to the emission position at the first end, and the second vertical mounting frame is close to the emission position at the second end.

In addition, the description of the three parts in the above embodiments may be referred to for other features of the ray source assembly, the detector assembly and the controller, and they will not be repeated here.

The present disclosure has been illustrated and described with reference to specific exemplary embodiments of the present disclosure, it should be understood by those skilled in the art that various modifications in form and details may be made to the present disclosure without departing from the spirit and scope of the present disclosure as defined by the appended claims and the equivalents thereof. Therefore, the scope of the present disclosure should not be limited to the above embodiments, but should be determined not only by the appended claims, but also by the equivalents of the appended claims.

1. An object detection device, comprising:
a support structure configured to form a passageway for a passage of a detected object;
a ray source assembly configured to emit a ray; and
a detector assembly comprising a detector mounting frame connected to the support structure and a plurality of detection units arranged on the detector mounting frame, the detection unit being configured to receive a transmission ray penetrating the detected object and obtain a detection information based on the transmission ray;
wherein the support structure comprises a vertical support arm having an adjustable height, and a vertical distance from the ray source assembly to a bottom portion of the support structure varies with a height of the vertical support arm.

2. The device according to claim 1, wherein,
the ray source assembly comprises a ray source cabin connected to the support structure and a ray source located in the ray source cabin; and
the ray source cabin has a plurality of emission positions, the ray source is configured to sequentially emit a ray from the plurality of emission positions to the detected object in the passageway, and centerlines of rays emitted from any two emission positions of the plurality of emission positions form an included angle to perform a multi-view transmission on the detected object.

3. The device according to claim 2, wherein the ray source is configured as one of:
the ray source is a movable ray source, and the movable ray source is configured to be sequentially moved to the plurality of emission positions and emit a ray;
the ray source is a distributed ray source, the distributed ray source comprises a plurality of emission units corresponding to the plurality of emission positions one to one, and the plurality of emission units are configured to sequentially emit a ray; and
the ray source comprises a plurality of independent ray sources, the plurality of independent ray sources are respectively arranged at the plurality of emission positions, and the plurality of independent ray sources are configured to sequentially emit a ray.

4. The device according to claim 2, wherein,
the vertical support arm comprises a first support arm and a second support arm, and each of the first support arm and the second support arm is a telescopic structure;
the support structure further comprises a transverse cabin connected between the first support arm and the second support arm; and
the ray source cabin is connected to the transverse cabin, and the ray source cabin is configured to move along an extending direction of the transverse cabin.

5. The device according to claim 4, wherein,
the transverse cabin is configured to house a cooling device and a controller; and
the cooling device is configured to cool the ray source, and the controller is at least configured to control the ray source.

6. The device according to claim 1, wherein,
the detector mounting frame comprises a transverse mounting frame and a vertical mounting frame, and the vertical mounting frame comprises a first vertical mounting frame and a second vertical mounting frame respectively arranged on two sides of the transverse mounting frame;
wherein a height of at least one of the first vertical mounting frame and the second vertical mounting frame is adjustable; or a height of at least one of the first vertical mounting frame and the second vertical mounting frame is variable with a height of the vertical support arm.

7. The device according to claim 6, wherein,
the vertical support arm comprises a first support arm connected to the first vertical mounting frame and a second support arm connected to the second vertical mounting frame;
wherein a bottom portion of the first vertical mounting frame is rotatably connected to a bottom portion of the first support arm, and the first vertical mounting frame is configured to rotate around the bottom portion of the first support arm, so as to adjust a height of the first vertical mounting frame; and/or a bottom portion of the second vertical mounting frame is rotatably connected to a bottom portion of the second support arm, and the second vertical mounting frame is configured to rotate around the bottom portion of the second support arm, so as to adjust a height of the second vertical mounting frame.

8. The device according to claim 7, wherein,
the first support arm comprises a first support segment and a second support segment that is telescopic relative to the first support segment; and
the first vertical mounting frame comprises a first mounting segment fixedly connected to the first support segment and a second mounting segment fixedly connected to the second support segment, so that a length of the first vertical mounting frame varies with a telescoping of the second support segment.

9. The device according to claim 4, wherein,
the plurality of emission positions are distributed in a plane perpendicular to a travelling direction defined by the passageway; and
the ray source is arranged so that rays emitted at the plurality of emission positions are all coplanar with the plurality of detection units;
wherein the ray source is configured so that rays emitted at partial emission positions of the plurality of emission positions are incident at least from a top portion of the detected object, and rays emitted by the ray source at partial emission positions of the plurality of emission positions are incident at least from a second side edge of the detected object.

10. The device according to claim 9, wherein,
a connecting line of the plurality of emission positions is in an arc shape or a zigzag shape, wherein a vertical distance from an emission position at a first end to a bottom portion of the support structure is greater than a vertical distance from an emission position at a second end to the bottom portion of the support structure; and
the ray source assembly is located in a corner area of the support structure and is close to a top portion and a second side portion of the support structure.

11. The device according to claim 1, wherein,
the vertical support arm comprises a first support arm and a second support arm, and the ray source assembly is connected between the first support arm and the second support arm;
wherein the support structure further comprises a base seat connected to the first support arm and the second support arm, each of the first support arm and the second support arm is configured to rotate relative to the base seat, and during a rotation of the first support arm and the second support arm relative to the base seat, a height of the ray source assembly varies; or
wherein each of the first support arm and the second support arm is a telescopic structure, and during a telescoping process of the first support arm and the second support arm, the height of the ray source assembly varies.

12. The device according to claim 2, further comprising:
a controller configured to control the ray source to sequentially emit a ray from the plurality of emission positions to the detected object, and control the plurality of detection units to sequentially obtain a detection information corresponding to a ray emitted from each emission position; and
a processor configured to obtain a scanned image at a viewing angle corresponding to each emission position according to the detection information, and perform a three-dimensional reconstruction processing according to the scanned image at a viewing angle corresponding to each emission position.

13. The device according to claim 3, wherein,
the ray source assembly further comprises a collimator, the collimator being located on a side of a ray emission of the ray source cabin, and the collimator being configured to adjust a ray emitted from the plurality of emission positions;
wherein in a case that the ray source is a distributed ray source, the collimator is a segmented collimator, and a parameter of each segment of the collimator is adjusted separately; and
wherein in a case that the ray source comprises a plurality of independent ray sources, the collimator is an integral collimator, and a parameter of the integral collimator is adjusted uniformly.

14. The device according to claim 12, further comprising:
a conveying device arranged at the bottom portion of the support structure, and configured to convey the detected object to pass through the passageway;
an anti-collision sensor arranged at the vertical support arm, and configured to detect a distance between the detected object and the vertical support arm;
wherein the controller is further configured to control the conveying device, the ray source and the plurality of detection units according to the distance between the detected object and the vertical support arm.

15. The device according to claim 12, further comprising:
a collection device configured to collect an identification information of the detected object;
wherein the processor is further configured to establish a corresponding relationship between the identification information of the detected object and the scanned image.

16. The device according to claim 12, wherein,
the processor is further configured to determine a target detection mode from a plurality of preset detection modes according to a current detection portion of the detected object, and perform a detection on the detected object based on the target detection mode;
wherein, in different detection modes, different numbers of emission positions are used to emit a ray; in a first scanning mode of a plurality of scanning modes, a single emission position of the plurality of emission positions is used to emit a ray; and in a second scanning mode of the plurality of scanning modes, the plurality of emission positions are used to emit a ray.

17. The device according to claim 12, wherein,
the processor is further configured to determine one or more target emission positions from the plurality of emission positions according to a user instruction; and
the controller is further configured to control the ray source to sequentially emit a ray to the detected object at the one or more target emission positions.

18. The device according to claim 8, wherein,
the first support segment and the second support segment are provided with a guide structure for defining a moving direction of the second support segment; and/or
the first support segment and/or the second support segment is provided with a locking device for restricting a movement of the second support segment after the second support segment moves to a set position of the first support segment,
wherein the device further comprises:
two protective baffles, respectively connected to two sides of the support structure, the protective baffle having an unfolded state and a folded state;
wherein when the protective baffle is in the unfolded state, the two protective baffles both extend along the traveling direction defined by the passageway; and when the protective baffle is in the folded state, the two protective baffles are folded to two sides of the passageway.

19. (canceled)

20. An object detection device, comprising:
a ray source assembly comprising a ray source cabin and a ray source located in the ray source cabin, the ray source cabin having a plurality of emission positions;
a detector assembly comprising a detector mounting frame and a plurality of detection units arranged on the detector mounting frame, wherein the detector mounting frame comprises a transverse mounting frame and a first vertical mounting frame and a second vertical mounting frame respectively arranged on two sides of the transverse mounting frame; and
a controller configured to control the ray source to sequentially emit a ray from the plurality of emission positions, and control the detection unit to sequentially receive a ray emitted from each emission position of the plurality of emission positions, wherein centerlines of rays emitted from any two emission positions of the plurality of emission positions form an included angle.

21. The device according to claim 20, wherein the ray source is configured as one of the following:
the ray source is a movable ray source, and the movable ray source is configured to be sequentially moved to the plurality of emission positions and emit a ray;
the ray source is a distributed ray source, the distributed ray source comprises a plurality of emission units corresponding to the plurality of emission positions one to one, and the plurality of emission units are configured to sequentially emit a ray; and
the ray source comprises a plurality of independent ray sources, the plurality of independent ray sources are respectively arranged at the plurality of emission positions, and the plurality of independent ray sources are configured to sequentially emit a ray,
wherein a connecting line of the plurality of emission positions is in an arc shape or a zigzag shape, wherein a vertical distance from an emission position at a first end of the plurality of emission positions to a bottom portion of the object detection device is greater than a vertical distance from an emission position at a second end to the bottom portion of the object detection device.

22. (canceled)
